(19) United States
(12) Patent Application Publication
(10) Pub. No.: US 2013/0197158 A1
(43) Pub. Date: Aug. 1, 2013

(54) SELF-ALIGNED GRAPHENE POLYMER NANOCOMPOSITES

(71) Applicant: HENKEL CORPORATION, Rocky Hill, CT (US)

(72) Inventors: Jang Kyo Kim, Kowloon (CN); Allison Yue Xiao, Belle Mead, CA (US); Qingbin Zheng, Kowloon (CN); Jie Cao, Hillsborough, NJ (US); Yayun Liu, Franklin Park, NJ (US); Seyed Hamed Aboutalebi, Kowloon (CN); Mohsen M. Gudarzi, Kowloon (CN)

(73) Assignee: HENKEL CORPORATION, Rocky Hill, CT (US)

(21) Appl. No.: 13/803,282

(22) Filed: Mar. 14, 2013

Related U.S. Application Data
(63) Continuation of application No. PCT/US2012/026550, filed on Feb. 24, 2012.
(60) Provisional application No. 61/446,584, filed on Feb. 25, 2011.

(51) Int. Cl. C08L 75/04; B05D 3/02

(52) U.S. Cl. CPC C08L 75/04; B05D 3/0254
USPC 524/590; 427/385.5

(57) ABSTRACT

Highly-oriented graphene polymer nanocomposites are produced from an aqueous dispersion of graphene oxide in polyurethane latex followed by chemical reduction to form graphene sheets.

### BACKGROUND OF THE INVENTION

Graphene is one of the thinnest and strongest materials known, with exceptionally high electron mobility and heat conductivity; consequently, it has generated interest in various industries for finding ways to harness these properties for practical applications. One potential way is to incorporate graphene sheets into a polymer composite material. Unfortunately, the introduction of fine dispersions of graphene into polymer hosts is difficult, mainly because of the strong bonding within the graphene and the need for sophisticated treatment with organic solvents.

To overcome this difficulty, aqueous dispersions of graphene oxide (GO) are mixed with polymer latex, and the GO is reduced to incorporate graphene into the polymer matrix. In many cases, the graphene irreversibly agglomerates in the polymer matrix rather than forming a uniform dispersion. A uniform dispersion would be preferred, because it is believed that it would lead to better performance properties in the resultant composite. The irreversible aggregation of graphene sheets during the reduction of GO is a strong motivation to produce stable reduced GO dispersions. Thus, it would be an advantage to be able to form a stable, un-agglomerated nanocomposite of graphene and polymer with advantageous performance properties.

### SUMMARY OF THE INVENTION

This invention is a nanocomposite of self-aligned graphene and polyurethane. In one embodiment this invention is a graphene-polyurethane nanocomposite comprising greater than 2 wt % or greater of graphene, characterized in that the graphene and polyurethane self-align into layers. In another embodiment, this invention is a graphene-polyurethane nanocomposite comprising from 2 to 5 wt % graphene, characterized in that the graphene and polyurethane self-align into layers. In a further embodiment this invention is a graphene-polyurethane nanocomposite comprising 0.01 to 2 wt % graphene, characterized in that the graphene and polyurethane form dispersed nanocomposites.

In another embodiment, this invention is a method of forming a self-aligned graphene-polyurethane nanocomposite comprising (i) mixing aqueous dispersions of graphene oxide and polyurethane and (ii) adding an effective amount of hydrazine to reduce the graphene oxide to graphene. In one embodiment, the resultant graphene is present in an amount of 2 wt % or greater; in another embodiment, the resultant graphene is present in an amount of 2 to 5 wt %. In a further embodiment, this invention is a method of forming a dispersed graphene-polyurethane nanocomposite comprising (i) mixing aqueous dispersions of graphene oxide and polyurethane and (ii) adding an effective amount of hydrazine to reduce the graphene oxide to graphene. In one embodiment, sufficient graphene oxide is present to yield, after reduction, a resultant graphene content from 0.01 to 5 wt %. In one embodiment the resultant graphene is present in an amount from 0.01 to 2 wt %. In another embodiment the resultant graphene is present in an amount from 2 to 5 wt %. In some instances, the graphene is present in amounts greater than 5 wt %.

The polyurethane latex acts as stabilizer for both the reduced GO and the newly formed polymer-graphene matrix. Interparticle polarity between the GO sheets and the aqueous dispersed polyurethane particles is considered the key underlying mechanism for the stabilization, and leads to a homogenous dispersion of graphene nanolayers that self-orient or self-align during formation. The strong interaction of the graphene nanolayers with the polyurethane results in improved performance properties over the corresponding neat polyurethane matrix or the properties of a nanocomposite prepared from graphene and a different neat polymer.

### BRIEF DESCRIPTION OF THE DRAWINGS

FIG. 1 is a graph of the Zeta potentials of dispersion of PU, GO and PU-GO hybrids. The numbers indicate the concentration of particles in mg/ml.

FIG. 2 is a digital photograph of GO, PU-rGO, and rGO dispersions.

FIG. 3a is a UV-Vis spectra of GO and PU-rGO at different concentrations. FIG. 3b is a Beer's Law graph of the absorbance of PU-rGO dispersions at 550 nm plotted against graphene concentration.

FIG. 4 shows an AFM image of a) GO and b) PU-rGO nanolayers coated on the surface of a silicon wafer, with a scan size of 10×10 μm; and a TEM micrograph of c) GO and d) PU-rGO, in which the scale bar is 1 μm.

FIG. 5 shows SEM images of the freeze fracture surface of PU nano-composites containing a), b) 0.5 wt % and c), d) 1 wt % graphene.

FIG. 6 shows SEM images of a freeze fractured surface of PU nanocomposites containing a), b) 2 wt % and c), d) 5 wt % graphene

FIG. 7 is a graph of the electrical conductivity (σ) of PU composite as a function of graphene content (ρ). The inset is a graph of log σ plotted against log(ρ-ρ_{c}), where σ_{c} is the percolation threshold. The value ρ_{c} was calculated based on the best linear fitting of data on power law equation.

FIG. 8 is a graph of the elastic modulus and hardness (nano-indentation result) for PU composites as a function of graphene content.

FIG. 9 is a typical stress-strain curve for PU-graphene composites.

FIG. 10 is a graph of the Young's modulus of PU composites plotted against the volume fraction of graphene.

FIG. 11 is a graph of weight loss versus time for neat PU and graphene/PU nanocomposites (measured using dry samples).

FIG. 12 is a graph of weight loss versus time curves for neat PU and graphene/PU nanocomposites (measured after saturation with water for 150 h).

FIG. 13 is a graph of water vapor transmission (WVT) rates for neat PU and graphene/PU nanocomposites.

### DETAILED DESCRIPTION OF THE INVENTION

In this description the following terms shall have the following meanings:
AFM is atomic force microscope.
GO is graphene oxide.
PU is polyurethane.
rGO is reduced graphene oxide.
SEM is scanning electron micrography.
TEM is transmission electron micrography.
UV-VIS is ultraviolet and visible light.

This invention is directed to graphene/polyurethane composites that self-align. The composites are prepared by mixing an aqueous dispersion of polyurethane (PU) and an aqueous dispersion of graphene oxide (GO). Employing a GO dispersion in water for the fabrication of polymer composites is mainly governed by the solubility of the polymer in water. Therefore, polymers that can form aqueous dispersions are suitable to be combined with a GO dispersion in order to fabricate highly dispersed composites. In order to produce a conductive composite, the GO must be reduced to graphene. The reduction of the graphene oxide to graphene occurs in the presence of an aqueous dispersion of polyurethane and is accomplished by the addition of hydrazine, which reduces the graphene oxide. The reduction of the GO to graphene enables the incorporation of graphene into the polyurethane matrix at a level up to 5 wt %. In some instances, higher amounts of graphene may be incorporated.

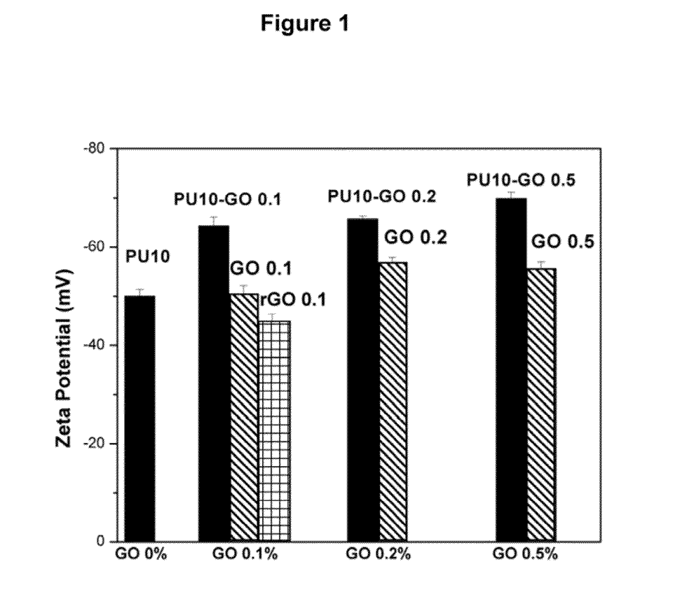

The use of polyurethane latex stabilizes both the reduced GO and the newly formed polymer-graphene matrix. The stability arises from the ionization of oxygen groups on the graphene oxide and on the polyurethane. A zeta potential |ξ| study of a GO dispersion demonstrated that GO nanosheets are negatively charged. Zeta potentials of the dispersions with various graphene concentrations were measured on an analyzer (Brookhaven ZetaPlus) at room temperature. FIG. 1 is a graph of the results of that study. Dispersions of polyurethane, graphene oxide, and mixtures of a polyurethane dispersion and graphene oxide dispersion, were prepared and their zeta potentials measured. The level of graphene oxide in the dispersions was varied at 0%, 0.1%, 0.2% and 0.5% by weight (shown on X axis). The concentrations of particles of polyurethane and graphene oxide are indicated as numbers having a unit value of mg/ml. (For example, PU 10-GO 0.1 indicates a mixed dispersion of polyurethane and graphene oxide in which the concentration of polyurethane is 10 mg/ml and the concentration of graphene oxide is 0.1 mg/ml.)

Waterborne polyurethane lattices, suitable for use in the composites of this invention, are emulsion systems containing urethane-urea polymer dispersions. The urethane-urea dispersions are prepared by reacting a polyol, a diisocyanate, a catalyst, a chain extender, water, and optionally, a neutralizing agent.

Typical polyols include, but are not limited to, hydroxylated polybutadienes, hydroxyl or polyhydroxy-containing polyesters, and polyether polyols. Preferred polyol monomers can be selected from neopentylglycol, ethyleneglycol, diethyleneglycol, hexamethyleneglycol, 1,4- and 1,3-butyleneglycols, 1,3- and 1,2-propyleneglycols, and the corresponding dipropyleneglycols; trimethylolethane, trimethylolpropane, 1,2,4-butanetriol, 1,2,6-hexanetriol, glycerol, and triethanolamine; trihydroxymethyl benzene.

Polyether polyols are prepared from alkylene oxides containing from two to about four carbon atoms, including, for example, ethylene oxide, 1,2-propyiene oxide and 1,2-butylene oxide, and their homopolymers and copolymers. Polyhydric, polyalkylene ether can also be prepared from reagents such as glycidol and cyclic ethers, such as tetramethylene ethers, and the epihalohydrins. The polyaralkylene ether polyols are derived from the corresponding aralkylene oxides, such as, for example, styrene oxide, alone or mixed with alkylene oxide.

Other useful polyols are those based upon various saturated and unsaturated hydrocarbons such as poly BD R-445HT and R65M (both available from Sartomer, Inc.); LIR-503 (KL-5) available from Kuraray Co., Ltd.); and polyols modified by grafting styrene and an acrylonitrile, such as Pluracol 637, Pluracol 1002, or Pluracol 1028 (all available from BASF Corp.)

Suitable organic polyisocyanates include those containing at least two isocyanate groups per molecule, including aromatic, aliphatic, cycloaliphatic, and trimeric isocyanates. Exemplary organic polyisocyanates include, for example, n-butylene diisocyanate, methylene diisocyanate, m-xylylene diisocyanate, pxylylene diisocyanate, cyclohexyl-1,4-diisocyanate, dicyclohexylmethane4,4′-diisocyanate, m-phenylene diisocyanate, p-phenylene diisocyanate, 3-(alpha-isocyanatoethyl)-phenyl isocyanate, 2,6-diethylbenzene-1,4-diisocyanate, diphenyl-dimethylmethane-4,4′diisocyanate, ethylidene diisocyanate, propylene-1,2-diisocyanate, cyclohexylene-1,2diisocyanate, 2,4-tolylene diisocyanate, 2,6-tolylene diisocyanate, 3,3′-dimethyl-4,4′biphenylene diisocyanate, 3,3′-dimethoxy4,4′-biphenylene diisocyanate, 3,3′-diphenyl4,4′-biphenylene diisocyanate, 4,4′-biphenylene diisocyanate, 3,3′-dichloro-4,4′biphenylene diisocyanate, 15-naphthalene diisocyanate, diphenylmethane diisocyanate, 1,6hexamethylene diisocyanate and isophorone diisocyanate.

The aromatic, aliphatic diisocyanates and the cyclocaliphatic diisocyanates are preferred; specific examples include dicyclohexyl methane 4,4′ diisocyanate (H12 MDI), isophorone diisocyanate (IPDI), and aromatic isocyanates including toluene diisocyanate (TDI), and diphenyl methane diisocyanate.

A catalyst is generally preferably present to increase the rate of reaction, especially between the polyisocyanate and the polyol. Catalysts useful for this reaction are well known in the art and include, for example, metal catalysts such as tin, bismuth, cobalt, lead, and vanadium compounds. Most preferred are the tin compounds, e.g. stannous octoate, stannous acetate, stannous oleate, stannic diacetate, stannic di-octoate, dibutylin diactate, dibutylin dilaurate, and tributyltin oxide.

A chain extender can include an acid functional diol, tertiary alkanolamine or hydrophilic group containing diol. A suitable neutralizing agent is, for example, triethylamine.

The reaction is generally initiated by admixing the polymeric polyol with an acid functional diol or tertiary alkanolamine, or with a diol containing a hydrophilic group and the polyisocyanate. In some embodiments, a neutralizing agent, for example, the triethylamine, is added following substantial completion of this reaction, and cooling to almost room temperature. In other embodiments, the neutralizing agent is not used,

The polyurethane-urea dispersion may also employ other lattices, for example, acrylics, synthetic and natural rubbers, neoprenes, nitrile rubber, butyl rubber, polybutadiene, styrene-acrylic, styrenebutadiene, acrylonitrile, styrene-butadiene or styrene-isoprene block copolymers, and chlorosulfonated polyethylene.

FIG. 1 is a graph showing the zeta potentials of polyurethane and graphene oxide dispersions. The Zeta potentials were measured on an analyzer (Brookhaven ZetaPlus) at room temperature and are the average values of the results obtained from 25 runs for a given condition are reported. The graph shows that a PU dispersion has a zeta potential of −50 mV (ξ=−50 mV), which indicates that the PU consists of nanoscopic particles with negatively charged groups on their surfaces. Upon mixing the PU dispersion with GO dispersions of varying concentrations, the zeta potential decreased to between approximately −60 mV to −70 mV, depending on the graphene oxide level, which levels are lower than the zeta potentials for the individual GO or PU dispersions, suggesting the higher stability of the mixed solution. Reducing the GO to graphene (indicated as “rGO” on the graph) causes the zeta potential value to increase to around −45 mV, implying the partial removal or neutralization of some oxygen groups in the final reduced GO structure. Nonetheless, the stability of graphene-PU is assured due to the relatively high |ξ|.

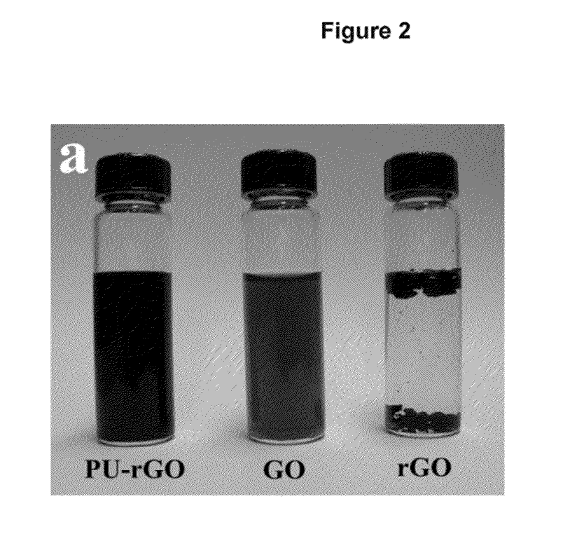

The presence of water as a solvent also aids in the stability of the reduced GO and the polyurethane-graphene matrix. Dispersions of graphene oxide, reduced graphene oxide, and a mixture of polyurethane and reduced graphene oxide (rGO) were prepared and allowed to stand for several months. The dispersion of reduced graphene oxide (without polyurethane) resulted in a significant degree of agglomeration of the resulting graphene nanosheets. The dispersion of graphene oxide and the dispersion of the mixture of polyurethane and reduced graphene oxide remained stable without any graphene aggregation. FIG. 2 is a digital photograph of the dispersions.

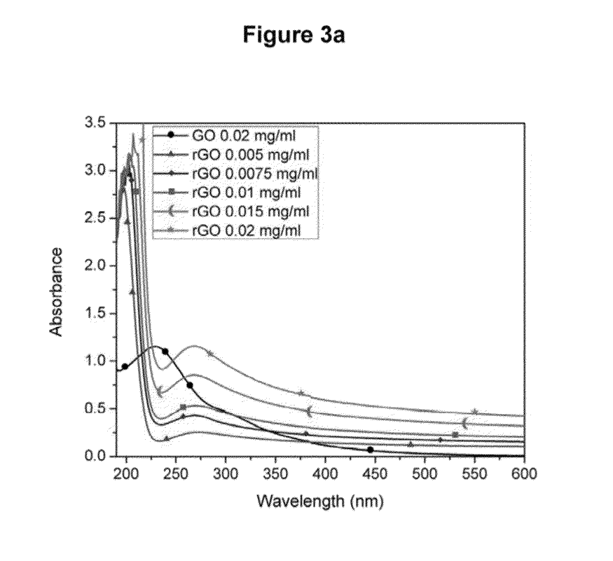

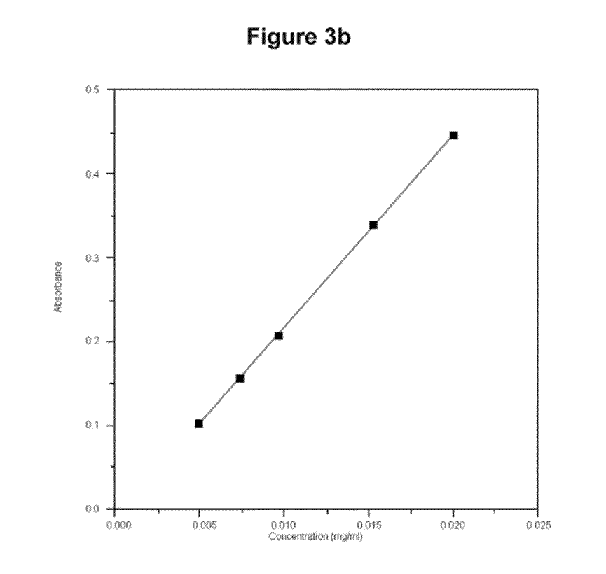

FIG. 3a depicts the UV-Vis spectra of various GO and PU-graphene dispersions. The GO spectrum demonstrates an adsorption peak at 230 nm with a shoulder at 300 nm which is attributed to π→π* and n→πtransitions, respectively. The degree of reduction of GO sheets and the homogeneity of PU-rGO composites were evaluated by UV/VIS spectroscopy (using a Perkin Elmer Lambda 20). The reduction of GO to graphene resulted in a red peak shift from 230 nm to 270 nm and the disappearance of the shoulder, implying the restoration of a conjugated structure. FIG. 3b shows that the adsorption intensity of the same PU-graphene dispersions is linearly proportional to the concentration of graphene, indicating the validity of Beer's law, and in turn, the high solubility of the PU-rGO in water.

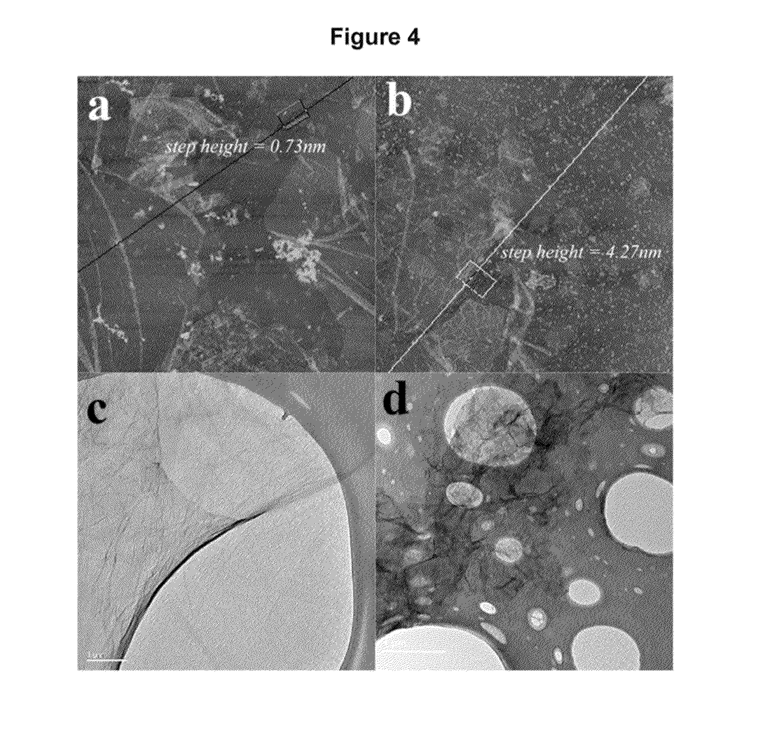

AFM and TEM images of graphene oxide and PU-graphene composites were studied and are shown in FIG. 4. The AFM image a) in FIG. 4 shows that the thickness of the GO is around 0.7-1 nm, which is a typical value for a monolayer of oxidized graphene. The AFM image b) in FIG. 4 shows nanosheets with a thickness 4-5 nm formed from compounding GO and PU, followed by the reduction of GO. Such an increase in the thickness of graphene layers is an indication of forming a PU layer on the surface of the graphene. Due to the low glass transition temperature (Tg) of PU (˜−30° C.), polymer particles are fused to each other and form a uniform polymer layer on both sides of the graphene layers.

The image in c) in FIG. 4 is a TEM micrograph of GO and shows that due to the atomically thin nature of graphene, GO sheets are observable as transparent layers in the TEM image. The image in d) of FIG. 4 shows that the incorporation of PU resulted in nanoplatelets with lower transparency and the formation of a polymer layer on the surface of the graphene sheets, similarly as shown in the AFM studies. The combination of polymer particles and graphene not only assures a molecular level dispersion of an atomically thin layer of carbon through the polymeric matrix, but also can be considered as a building block for the fabrication of graphene based composites.

The morphology of the composites was evaluated using transmission electron microscopy (TEM, JEOL 100X). The TEM samples were prepared by drying a droplet of the diluted suspension of PU-graphene on a carbon grid. The fracture surface of the composites was examined under a scanning electron microscope (SEM, JEOL 6390F). The SEM samples were prepared by fracturing in liquid nitrogen. The tapping-mode atomic force microscope (AFM, Digital Instruments) was employed to evaluate the morphology of GO and PU coated graphene sheets. The samples were prepared by dip coating a Si/SiO2 substrate in diluted dispersions.

The substrate was treated using 3-aminopropyltriethoxysilane (APTES, Aldrich) as follows: APTES was mixed with water (1:9 vol APTES, Water) and then one drop of hydrochloric Acid (HCl, 37%, Sigma Aldrich) was added to the solution. Si/SiO2 substrates were then introduced to the silane aqueous solution for 30 minutes to silanize them and then were washed thoroughly with deionized water. In order to prepare the PU-graphene dispersion for AFM study, the PU-graphene dispersion was centrifuged at 10 krpm for 20 min. The sediments were redispersed in water and used for sample preparation.

In the graphene-polyurethane composites of this invention, the graphene layers are visible as micrometer long nanosheets uniformly embedded in the polymer matrix with no indication of the aggregation of graphene layers. In addition, no debonding between the graphene layers and the matrix can be observed judging from the fact that no graphene sheet is directly exposed on the fracture surface. This observation indicates a strong interfacial bond between the composite constituents, which can be attributed to the molecular interaction of polar segments of the PU matrix with oxygen groups present on the graphene sheets. The fine dispersion of the graphene sheets and strong interfacial interaction are the two major factors governing the fabrication of strong and tough nanocomposites.

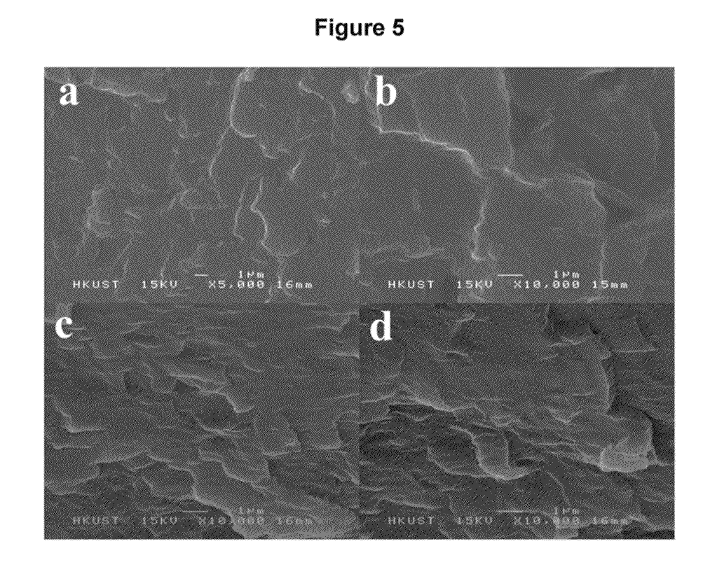

A study on the fracture surfaces of composites with graphene content at 0.5 to 1.0 wt % demonstrated well-dispersed graphene layers, as shown in FIG. 5. The graphene layers are visible as micrometer long nanosheets uniformly embedded in the polymer matrix with no indication of the aggregation of graphene layers. In addition, no debonding between the graphene layers and the matrix can be observed judging from the fact that no graphene sheet is directly exposed on the fracture surface. This observation indicates a strong interfacial bond between the composite constituents, which can be attributed to the molecular interaction of polar segments of the PU matrix with oxygen groups present on the graphene sheets. The fine dispersion of the graphene sheets and strong interfacial interaction are the two major factors governing the fabrication of strong and tough nanocomposites. At such graphene loading (0.5 to 1.0 wt %), limited graphene orientation was observed in the composites owing to the relative weak graphene basal plane interaction at such concentration range.

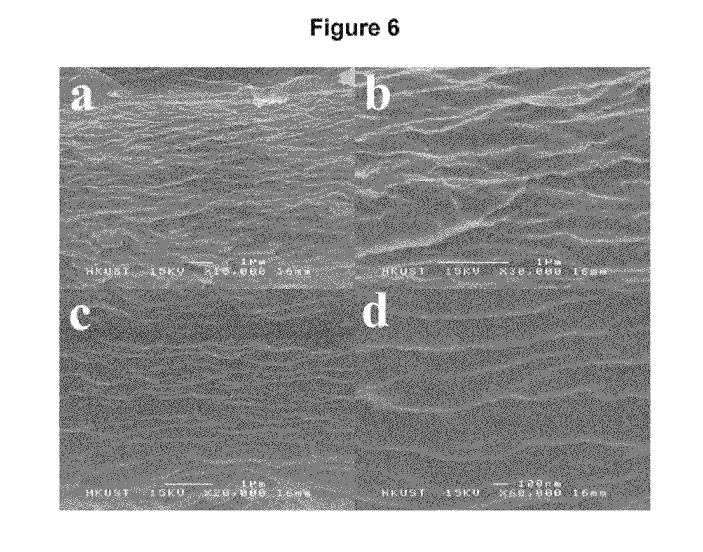

A study on the fracture surfaces of composites with higher graphene content (>2 wt %) revealed significant orientation of graphene sheets, as shown in FIG. 6. As graphene concentration reached 2 wt %, graphene layers adjusted their basal plane perpendicular to the film thickness, resulting in partial alignment of graphene layers. Highly aligned graphene layers in PU matrix were observed at 5 wt % of nanosheets. The self-alignment of graphene sheets occurred during the evaporation of water without any external forces.

In contrast with carbon nanotubes in which complicated functionalization processes are required to tune the dispersion and interfacial interaction, here by taking advantage of the presence of polar groups in the chemical structure of both graphene and PU, an improvement in bonding interaction is achieved.

### SYNTHETIC EXAMPLE 1

The GO was synthesized based on a modified Hummer's method using expanded graphite (from Asbury Graphite Mills, US). The obtained GO particles were diluted using deionized water (˜1 mg/ml) and sonicated using bath sonication for 20 minutes, followed by probe sonication for 10 minutes. The GO dispersion was added to an aqueous emulsion of polyurethane (PU, Neorez R967 supplied by DSM NeoResin), which was mildly mixed to obtain a homogeneous aqueous dispersion. The GO sheets were reduced to graphene sheets (rGO) by adding hydrazine solution to the dispersion in the weight ratio of hydrazine to GO of 3:1. The dispersion was then heated at 80° C. for 24 hours. To produce composite films, the resulting mixture containing reduced GO and PU emulsion was poured into a flat mold and dried in an oven at 50° C. for six hours. The addition of graphene sheets into the PU matrix resulted in uniformly black polymer films. A film prepared from the same PU without the graphene was transparent.

### PERFORMANCE EXAMPLE 2

### Electrical Conductivity

The electrical conductivity of the composite films was measured employing the four-point probe method (Scientific Equipment & Services). To reduce the contact resistance between the probes and the film surface, the samples were coated with silver paste at contact positions. A rapid increase in conductivity of a polymer matrix is observed as the concentration of conductive filler reaches a threshold value, known as the percolation threshold. The percolation threshold strongly depends on the size and geometry of the filler and also the dispersion state. High aspect ratio and fine dispersion are required to decrease the percolation threshold of a composite. Percolation thresholds as low as few tenths of weight percent of high aspect ratio filler, such as, CNTs, graphite nanoplatelets, metal nanowires, have been achieved where the fillers are finely dispersed. It has now been found that graphene can also serve as a highly conducting filler for the fabrication of conductive composites with exceptionally low percolation threshold.

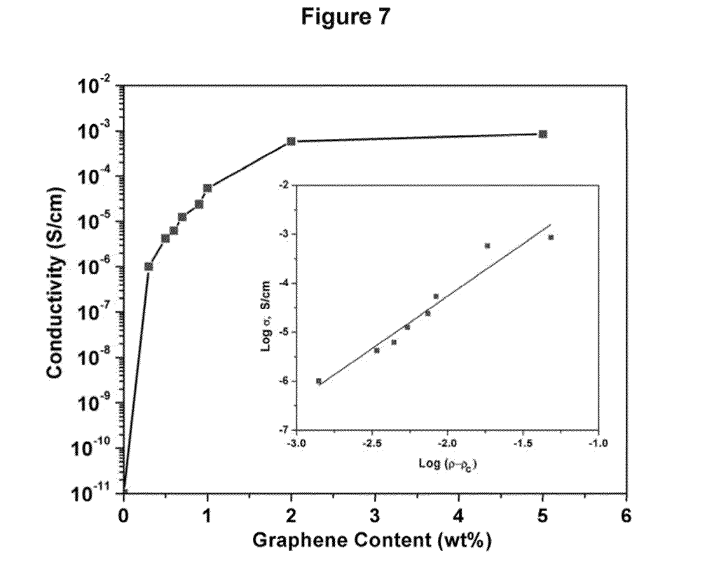

FIG. 7 depicts the electrical conductivity of graphene-PU composites as a function of graphene content. The electrical conductivity increased exponentially at the low graphene content, followed by rather slow growth at high contents over 2 wt %. Due to the fine dispersion of graphene in the PU matrix, the electrical conductivity rapidly increased resulting in a seven order increase in conductivity with a very low graphene content of 0.5 wt %. A further increase in graphene content beyond 2 wt % resulted in a saturated conductivity. An electrical conductivity of 0.09 S/m corresponding to a high graphene content of 2 to 5 wt % is sufficiently high for applications such as conductive adhesive and composites for electrostatic and electromagnetic dissipation.

### PERFORMANCE EXAMPLE 3

### Mechanical Properties

The hardness and elastic modulus of the composites were measured at room temperature using a depth-sensing nanohardness tester (Nanoindenter XP, MTS Systems) with a Berkovich diamond indenter. The maximum load applied was 100 mN, and the loading and unloading rate of indentation was 1 mN sec⁻¹ with an allowable drift rate of 0.5 nm/sec. The holding time at maximum load was 30 seconds. The nanohardness and elastic modulus were calculated from the load—displacement curves. The tensile tests were conducted with a dynamic mechanical analyzer (DMA 7, Perkin Elmer). Composite films were cut into 15×3 mm strips. All tensile tests were conducted in controlled force mode with a preload of 100 mN and a force ramp rate of 100 mN

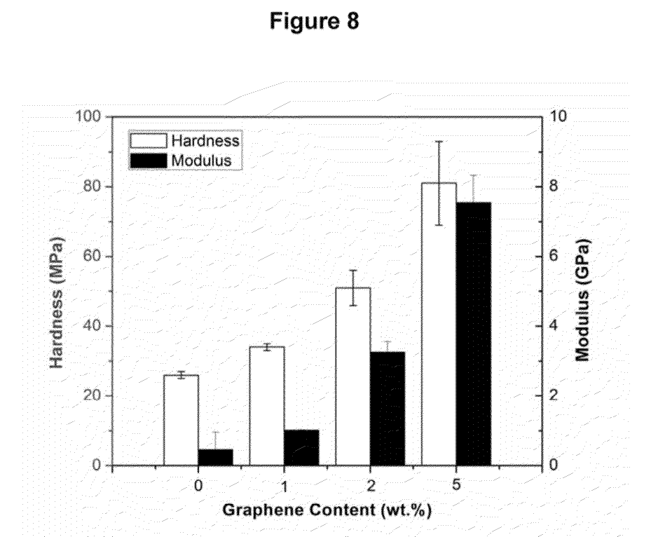

Nano-indentation and tensile tests were performed to evaluate the mechanical properties of composites. The elastic modulus and hardness values measured from the unloading curves are shown in FIG. 8. Modulus and hardness of composites monotonically rise as graphene content increases, implying the presence of highly dispersed nanosheets in composite. The incorporation 5 wt % of graphene increased both the modulus and hardness of nanocomposites by approximately 1200% and 300%, respectively. Uniform dispersion of graphene sheets and strong interfacial interaction between the graphene and matrix were responsible for the significant improvement in mechanical properties.

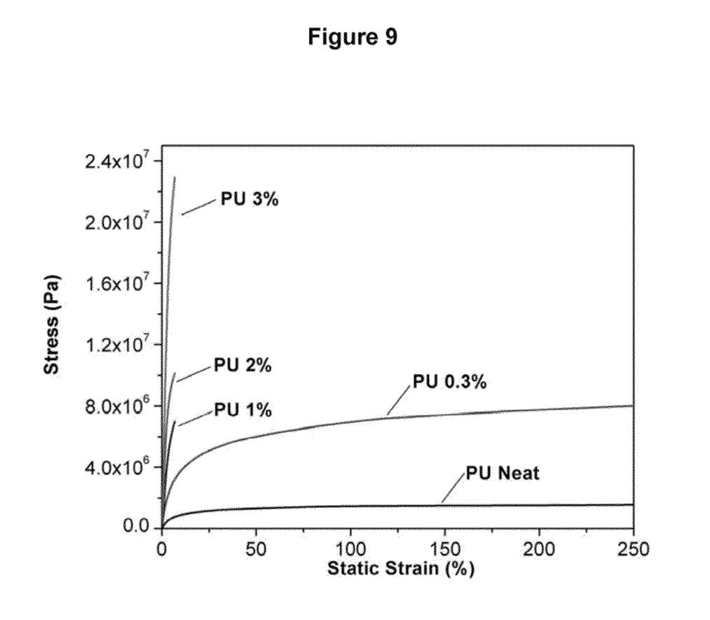

FIG. 9 shows typical strain-stress curve for PU and nanocomposites containing different amounts of graphene. The addition of a small amount of graphene remarkably affected the tensile properties of PU. Incorporation of merely 0.3 wt % into PU matrix resulted in 110 and 390% increase in modulus and tensile strength, respectively, while still sustaining the high deformability of the matrix. A monotonic enhancement in modulus and strength of composites was observed as graphene content increased. An enhancement in tensile modulus of the polymer matrix of 11 times was achieved by inclusion of 2 wt % graphene, and an enhancement of 21 times was achieved by the inclusion of 3 wt % graphene. Such improvement in mechanical properties of the PU matrix indicates the homogeneous dispersion of high aspect ratio carbon monolayers through the polymer media and strong bonding between them.

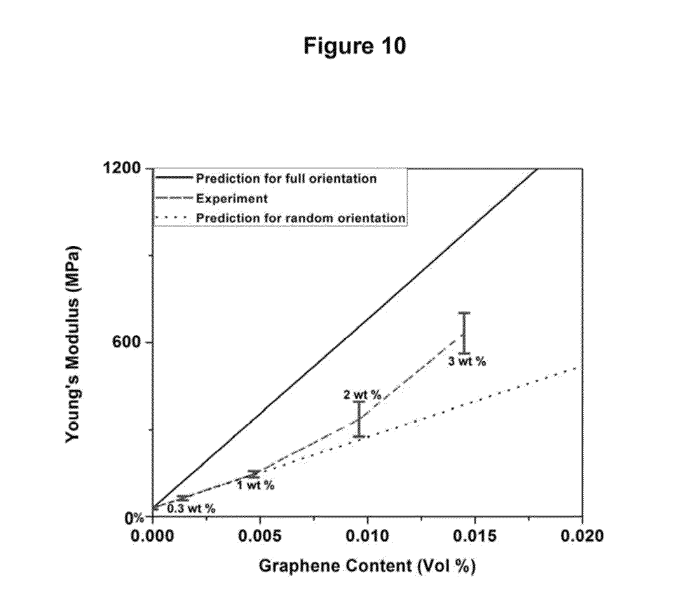

FIG. 10 is a graph of the Young's modulus of PU composites plotted against the volume fraction of graphene. The corresponding weight percent is recorded along the graph line. Data for composites containing graphene lower than 1 wt % were fitted by Halpin-Tsai equation for random distribution (dotted line). The calculated modulus for unidirectional oriented composite based on effective aspect ratio calculated from low graphene content composites is shown along the dashed line. The solid line is the theoretical modulus. The modulus of composites containing 2 and 3 wt % graphene is much higher than the predicted values for randomly oriented composites, approaching the expected values for fully aligned structure, confirming the self-organization of graphene layers upon an increase in filler content.

An effective aspect ratio of 13500 was calculated based on the above criteria for graphene. This value is consistent with the experimental observations and confirms the perfect dispersion and bonding between graphene nanosheets and PU. The modulus of composites containing 2 and 3 wt % graphene is much higher than the predicted values for randomly oriented composites, approaching the expected values for fully aligned structure, confirming the self-organization of graphene layers upon an increase in filler content.

### PERFORMANCE EXAMPLE 4

### Moisture Barrier Properties

The water vapor transmission (WVT) tests were performed according to the specification ASTM E96-66. All samples were dried in a vacuum oven for two days before the test. Because the graphene/PU nanocomposite samples were very thin (˜0.1 mm) and flexible, they tended to wrinkle and slacken very easily, especially when the samples were fully saturated with moisture. Hence, the method for WVT test was modified to suit the thin films. To avoid slackening of the thin films, the samples were sandwiched between two plastic sheets having a small window of 40 mm square in the center. The sandwich assembly was then attached onto the disk mouth using a sealant. The whole dish assembly was placed in a controlled environmental chamber and the weight of dish assembly was measured periodically to monitor the change in moisture contents in the dish. The conditioning environment of dish assembly and the content in the dish ensured that the relative humidity was close to zero on one side of the sample and was fully saturated on the other side. The water vapor permeated through the sample film from the side with a higher humidity to that with a lower humidity, resulting in the weight loss of dish assembly during the test.

This is attributed to the extremely high aspect ratio of the graphene sheets, which increased the tortuosity of the path of water molecules as they diffuse into the nanocomposite. The permeability performance of nanocomposites normally depends on the filler content, aspect ratio and degree of dispersion. In one embodiment, the moisture barrier properties of graphene/PU nanocomposites are demonstrated in a graphene/PU nanocomposite system containing graphene sheets up to 3 wt %.

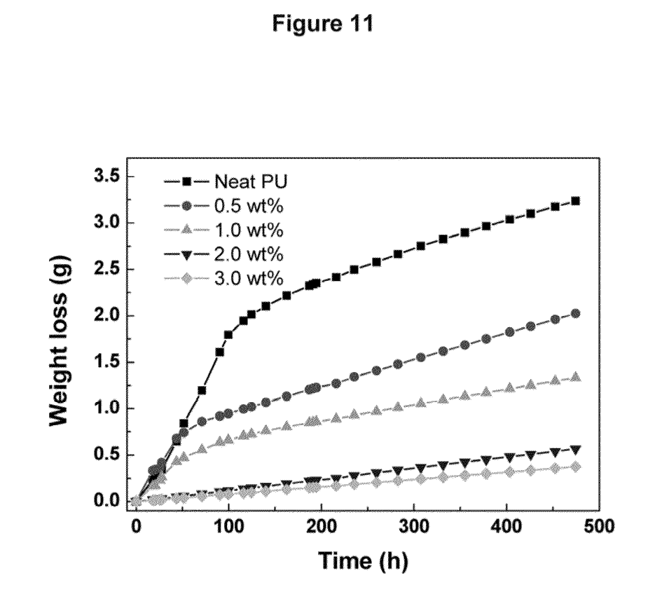

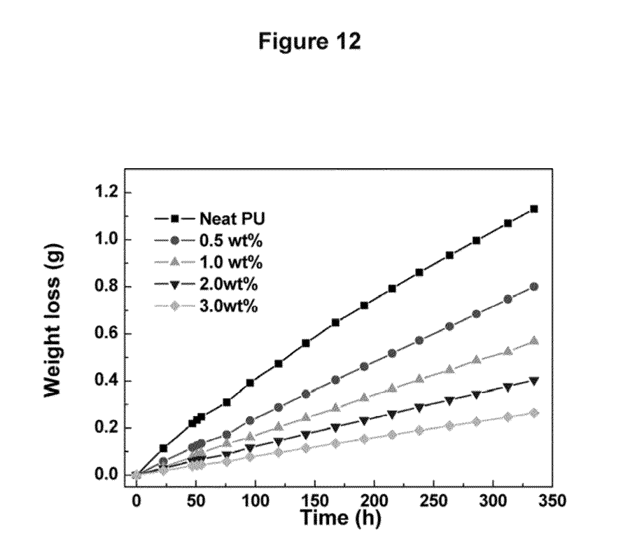

Weight changes after up to 475 hours of exposure for a neat PU and for a graphene/PU nanocomposite containing varying graphene content, 0.5 wt %, 1.0 wt %, 2.0 wt % and 3.0 wt %, were tested and the results presented in FIG. 11. The samples were completely dried in a vacuum oven, after which the weight change of the samples until complete saturation by moisture was observed and recorded. The weight changed rapidly at the initial stage until saturation by moisture. The abrupt changes in slope, especially in the neat PU and the composites with low graphene content indicate such saturation. The WVT tests were continued until the weight loss of all samples reached a constant rate, which was after about 150 hours. The weight loss as a function of time after the saturation period is plotted in FIG. 12.

The WVT rate was calculated according to the specification ASTM E 96 using the following equation WVT=G/tA=(G/t)/A (Eq. 1), where G is the weight change, t is the testing time, A is the test area (cup mouth area), and G/t is the slope of the straight line.

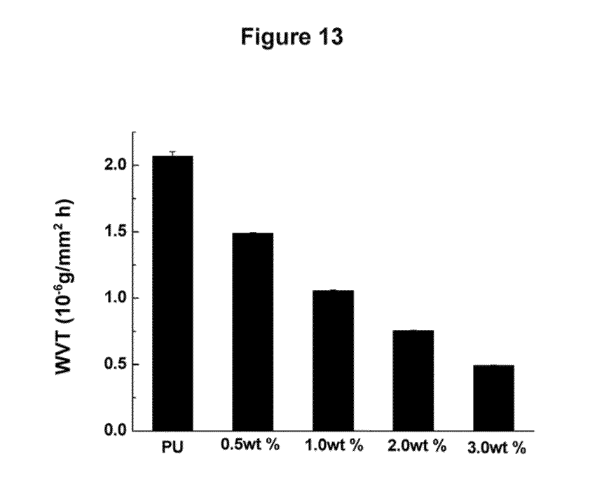

Based on the weight losses obtained during the steady stage, the WVT was calculated according to Eq. 1, and the results are shown in FIG. 13. The incorporation of graphene sheets as barrier filler reduced the WVT of PU up to 76% with only 3.0 wt % graphene content. The effectiveness of the graphene/PU nanocomposite as an effective moisture barrier was demonstrated.

### COMPARATIVE EXAMPLE 5

Graphene/polystyrene nanocomposites were prepared according to the methods described in this specification, except that polystyrene was used instead of polyurethane. Films of different thicknesses and compositions (with and without graphene nanosheets) were cast, but all of them cracked vigorously and massively as the water used in the graphene/polystyrene dispersions evaporated.

In an attempt to correct the film cracking, two approaches were taken. First, 10 wt % of the polyurethane latex used in the previous examples was blended with the polystyrene; nevertheless, the samples failed. Second, a plasticizer, sodium dodecylfulfate (SDS), was used in place of the polyurethane at the same amount. Although the plasticizer showed some remediation of the film formation problem, it failed to solve the problem completely. Further addition of SDS was not tried, as it is known that it can be detrimental to the properties of the films.

What is claimed:

1. A graphene-polyurethane nanocomposite comprising 2 wt % or greater of graphene, characterized in that the graphene and polyurethane self-align into layers.

2. The graphene-polyurethane nanocomposite of claim 1 comprising 2 to 5 wt % graphene, characterized in that the graphene and polyurethane self-align into layers.

3. A graphene-polyurethane nanocomposite comprising 0.01-2 wt % graphene, characterized in that the graphene and polyurethane form dispersed nanocomposites.

4. A method of forming a self-aligned or dispersed graphene-polyurethane nanocomposite comprising
(i) mixing aqueous dispersions of graphene oxide and polyurethane and
(ii) adding an effective amount of hydrazine to reduce the graphene oxide to graphene,
(iii) heating the dispersions, disposing the dispersions on a substrate, and drying the dispersions.

5. The method according to claim 4 in which the graphene oxide is added in sufficient amount to yield 2 to 5 wt % graphene in the self-aligned graphene-polyurethane nanocomposite.

6. The method according to claim 4 in which the graphene oxide is added in sufficient amount to yield 0.01-2 wt % graphene in the dispersed graphene-polyurethane nanocomposite.
